(19) United States
(12) Patent Application Publication
(10) Pub. No.: US 2011/0303408 A1
(43) Pub. Date: Dec. 15, 2011

(54) CONCENTRATION OF MINOR CONSTITUENT OF WELLBORE FLUID

(75) Inventors: Robert Seth Hartshorne, Suffolk (GB); Khooi Yeei Tan, Cambridgeshire (GB); Gary John Tustin, Cambridgeshire (GB)

(73) Assignee: Schlumberger Technology Corporation, Cambridge, MA (US)

(21) Appl. No.: 13/141,418

(22) PCT Filed: Nov. 16, 2009
(86) PCT No.: PCT/IB2009/007495

§ 371 Date: Sep. 1, 2011

(30) Foreign Application Priority Data
Jan. 21, 2009 (GB) 0900970.5

(51) Int. Cl. E21B 47/00; C09K 8/00

(52) U.S. Cl. 166/250.12; 507/200; 507/203

(57) ABSTRACT

A method of processing an aqueous fluid produced from a wellbore in order to collect or remove a minor constituent therefrom, comprises adding one or more solutes to the aqueous fluid so as to form an aqueous mixture which separates into two aqueous phases in contact with each other, with a first solute present at a greater concentration in the larger, first aqueous phase than in the second aqueous phase and a second solute present at a greater concentration in the smaller, second aqueous phase than in the first aqueous phase; while the compositions of the two phases are such that the said minor constituent preferentially partitions into the smaller, second aqueous phase so that the concentration of that constituent in the smaller second phase exceeds its concentration in the larger first aqueous phase. The second aqueous phase with the said constituent concentrated therein is then separated from the first aqueous phase. The process may be used to concentrate a tracer, such as an organic dye, into a reduced volume which can be transported to a remote laboratory. The process may alternatively be used to remove a contaminant or other minor constituent, so as to allow the first aqueous phase to be put to use, eg for cementing or hydraulic fracturing.

### FIELD OF THE INVENTION

This invention relates to the extraction of a minor constituent from an aqueous fluid produced via a wellbore from a subterranean source, which may be a hydrocarbon reservoir. The purpose of extraction may be analytical, where the ultimate objective is to detect or quantify a constituent of interest. Alternatively, the objective may be purification: to remove an unwanted constituent from the produced fluid.

### BACKGROUND OF THE INVENTION

There are a number of circumstances in which it would be useful to extract a constituent, present at a low concentration, from an aqueous fluid such as water or brine which has come from below ground. The purpose of such extraction may be analytical, when it is desired to detect the presence of a minor constituent, examples of this being analysis for a substance introduced to act as a tracer, analysis for a constituent which is naturally present at low concentration, and analysis to check whether a possible contaminant is below a permitted concentration.

Analysis of produced water with results available quickly (albeit not instantly) is an area of interest in the oil industry. An obstacle to performing analyses for a constituent present at low concentration is that a large quantity of water is likely to be required in order to provide a sample which is sufficiently representative and which contains a detectable quantity of the analyte. This would be an issue, no matter where the analysis is being carried out, but in the oil industry a wellbore and hence any fluid produced from it is likely to be at a remote location, far from analytical facilities. This exacerbates the issue because the transport of a large sample quantity of water to a laboratory is likely to be difficult and expensive and/or to cause delay in obtaining the analytical result.

Another circumstance where it would be desirable to extract a constituent present in low concentration arises when that constituent is an obstacle to using the water to perform a function below ground. For example, produced water may be used for cementing when completing an oil or gas well, but if so it is desirable that it should not contain an unknown quantity of lignosulphonate. Lignosulphonate is sometimes included in drilling mud and so can migrate into subterranean water while drilling a well. Lignosulphonate also functions as a cement retarder and is sometimes deliberately added to a cementing composition for this purpose, but the inadvertent inclusion of some unknown amount of it present as a contaminant in the water from the wellbore is detrimental to the quality of the cement. In parallel fashion, borate is sometimes added to a hydraulic fracturing fluid as a crosslinker for polymer in that fluid, but inadvertent inclusion of an unknown amount of borate present in the water which is used could cause premature or over-rapid crosslinking of the polymer during the course of the fracturing job.

### SUMMARY OF THE INVENTION

Broadly, this invention proposes to apply an aqueous extraction system to produced aqueous fluid to concentrate a constituent of interest into a reduced volume of aqueous solution. According to a first aspect of this invention there is provided a method of processing an aqueous fluid produced from a subterranean location via a wellbore to extract a minor constituent therefrom, comprising adding one or more solutes to the produced aqueous fluid so as to form an aqueous mixture
which exists as two aqueous phases in contact with each other and containing a plurality of dissolved solutes which segregate between the two phases such that at least one first solute is present at a greater concentration in the first aqueous phase than in the second aqueous phase while at least one second solute is present at a greater concentration in the second aqueous phase than in the first aqueous phase;
wherein the second of these two aqueous phases has a smaller volume than the first aqueous phase and the compositions of the two phases are such that the said minor constituent preferentially partitions into the second aqueous phase so that the concentration of that constituent in the second, smaller, phase exceeds the concentration in the first aqueous phase;
   and then separating the second phase with the said constituent concentrated therein from the first aqueous phase.

Aqueous systems which consist of two aqueous phases that remain as distinct phases even when placed in direct contact with each other have been known for a number of years. Such systems have been referred to as aqueous biphasic systems and have also been referred to as water-in-water emulsions or aqueous/aqueous emulsions when one phase is dispersed as droplets within the other. They have been used or proposed for possible use in various areas of technology, notably to give texture to foodstuffs, for extraction of biological materials, for the extraction of minerals and as personal washing compositions.

The two phases of an aqueous biphasic composition contain dissolved solutes which are sufficiently incompatible that they cause segregation into two phases. One solute (or one mixture of solutes) is relatively concentrated in one phase and another solute (or mixture of solutes) is relatively concentrated in the other phase. Possible combinations of solutes are:-
polymer/polymer eg guar/polyethylene glycol,
polymer/surfactant eg guar/non-ionic surfactant,
polymer/salt eg polyethylene glycol/ammonium sulphate,
surfactant/salt eg sodium dodecyl sulphate/ammonium sulphate, and
salt/salt eg tetrabutylammonium bromide/ammonium sulphate.
   There may be some overlap between these categories. For instance anionic and cationic surfactants are salts of organic acids and bases.

The process of the invention is applied to aqueous fluid, i.e. water or brine, produced from a subterranean location via a well bore. The process is likely to be carried out in the vicinity of that well bore.

The aqueous fluid produced from the reservoir may be water from an aquifer penetrated by the well bore or may be a fluid such as formation water or connate water produced from the well bore together with oil or gas. In such instances the water may be coming from a depth greater than 100 metres down the well bore.

The ultimate objective may be analytical, the process of the invention being used to concentrate an analyte present in the water from the wellbore into a smaller volume of the second aqueous phase. If it is required to transport the collected sample from the site of the wellbore to an analytical laboratory located elsewhere, the distance may be far enough that transport by road vehicle, rail, sea or air is required. Concentrating the analyte into a smaller sample volume will beneficially facilitate this by reducing the weight and volume to be transported. Concentrating the analyte into a smaller sample volume may may also assist when performing the subsequent analysis to determine the concentration of the analyte.

Alternatively, the ultimate objective may be water treatment to remove an unwanted constituent of the aqueous fluid from the produced water, or possibly to ensure the absence of an unwanted constituent whose presence is suspected, so allowing the produced aqueous fluid to be used for another purpose, or perhaps allowing it to be discharged safely.

More specifically produced water may be used for mixing cement of completing the well, or completing another well nearby. For instance water from a production well could be used for completing an adjacent injection well or a second production well. Another possibility is that water separated from produced oil might be stored and then used when carrying out hydraulic fracturing.

Carrying out such a water treatment may make it possible to avoid the cost of transporting water from elsewhere. There may then be an overall saving in costs even after allowing for the cost of apparatus for the process and materials to be added to the incoming aqueous fluid to cause separation into two phases.

It is possible that the process of the invention might be used in the analysis of produced water to determine the suitability of the water for use in cementing or hydraulic fracturing.

In the process of this invention the incoming aqueous fluid produced from a wellbore is mixed with one or more additional solutes to form an aqueous mixture which equilibrates as two aqueous phases, with the solutes distributed unevenly between the phases such that the first, larger, phase contains at least one solute at a higher concentration than its concentration in the second, smaller, aqueous phase while the second aqueous phase contains at least one solute at a higher concentration than its concentration in the larger first aqueous phase.

Solute which is preferentially concentrated in the first aqueous phase may be a single substance or a mixture of substances which are sufficiently compatible that they all concentrate in the same phase of an aqueous biphasic system and in particular, if the solute is inorganic salt, a mixture of inorganic salts may be used. Likewise, solute which concentrates in the second aqueous phase may be a mixture of substances which concentrate in the same phase.

Additional solute(s) which cause separation into two aqueous phases may be added in solid form and made to dissolve or may added in pre-mixed aqueous solution. If the incoming aqueous fluid produced via a wellbore is a brine from a subterranean geological formation, separation into two phases may be brought about by adding only one additional solute, possibly a polymer or an incompatible surfactant or salt. This additional solute could be mixed in as a solid, possibly by mixing Unto a portion of the incoming aqueous fluid to make a concentrate which is then mixed with the remainder of the incoming fluid. Alternatively it could be added as a concentrated aqueous solution made with fresh water from another source.

Applying the process of this invention in circumstances where the incoming fluid is already saline is advantageous in that the requirement for added solute(s) is reduced.

If the incoming fluid has low salinity it may be necessary to mix two solutes into it. Either or both might be mixed in as a solid or as a concentrated aqueous solution. Possibly the two solutes might be added as a concentrated aqueous mixture which is itself a biphasic system. For instance, if the incoming fluid is not already saline and it is intended to convert it into a biphasic aqueous mixture containing 2% polyethylene glycol and 2% of inorganic salt, these two solutes could be added in the form of an aqueous biphasic mixture containing 20% polyethylene glycol and 20% of the salt.

As mentioned above, a biphasic aqueous mixture can be formed with various combinations of solutes. However, it may be preferred that the solute which concentrates in the second aqueous phase is or includes a polymer. A number of polymers have been found to be effective in forming biphasic systems even if used in fairly low concentration so that using polymer for this purpose may be economical. Moreover, the phase diagrams for biphasic mixtures containing polymer tend to be such that if added polymer provides the solute which concentrates preferentially in the smaller volume second aqueous phase, then the concentration of polymer required in the other, larger volume, first aqueous phase can be low, thus limiting the consumption of added polymer.

As is well-known, some polymers have a thickening effect, i.e. they enhance the viscosity of water. For the process of the present invention it may be preferred to use a polymer with little or no effect on the viscosity of water, such as polyethylene glycol.

It is desirable that the second aqueous phase has a fairly small volume compared to the first aqueous phase, so that the minor constituent which it is desired to extract becomes concentrated into a small volume. Because the two phases share a common solvent, which is of course water, the relative volumes of the two phases can be controlled by means of the amounts of solutes in the overall aqueous mixture. These may be chosen so that the volume of the first aqueous phase is at least 5 and better at least 10 times the volume of the second aqueous phase.

However, the volume of the second phase should not be unduly small in relation to the volume of the first phase so that a sufficient quantity of the minor constituent can be extracted from the incoming fluid into this phase. The volume of the first phase may therefore be between 5 and 100 times the volume of the second aqueous phase.

For the same reason it will generally be desirable to choose the solutes in the two phases so that the concentration of the extracted constituent of interest in the second phase is high relative to both its concentration in the first phase and its original concentration in the incoming aqueous fluid. We have observed that organic molecules partition strongly into a second aqueous phase which is rich in an organic polymer or a surfactant or a salt of an organic acid when the other, larger volume, aqueous phase is rich in inorganic salt(s).

The solutes in the overall aqueous mixture may be chosen, in relation to each other and to the minor constituent which is to be extracted, such that the volume of the first aqueous phase is at least 5, better at least 10, times the volume of the second phase, the concentration of the minor constituent in the second aqueous phase is at least 10 times its concentration in the first aqueous phase, and the overall amount in the second aqueous phase is at least 3, 5 or better at least 10 times the amount in the first aqueous phase.

The minor constituent which is extracted from the incoming aqueous fluid into the second aqueous phase is likely to be in solution in the incoming aqueous fluid, although it might possibly be in suspension in that fluid but soluble in the second aqueous phase. This minor constituent may be something which is naturally present in the incoming fluid or may be a contaminant of that fluid introduced for instance during drilling of the wellbore. However, this invention is particularly applicable when the minor constituent is a tracer, that is a substance which is deliberately introduced into a reservoir so that its presence (or absence) in fluid produced from the reservoir will provide information. The use of tracers to obtain information about a hydrocarbon reservoir and/or about what is taking place therein (e.g. to monitor fluid paths and flow velocities) has been practised for several decades and has been described in numerous documents.

In a second aspect this invention applies the above method to the concentration of a tracer. Overall, this aspect of the invention provides a method of investigating a subterranean reservoir, comprising steps of
placing at least one tracer substance in the reservoir,
causing or allowing the tracer to dissolve in aqueous reservoir fluid,
producing the fluid from the reservoir,
applying the method of the invention by adding one or more solutes to the aqueous fluid so as to form an aqueous mixture
   which exists as two aqueous phases in contact with each other, with the dissolved solutes segregated between the two phases such that at least one first solute is present at a greater concentration in the first aqueous phase than in the second aqueous phase while at least one second solute is present at a greater concentration in the second aqueous phase than in the first aqueous phase;
   and wherein the second aqueous phase has a smaller volume than the first aqueous phase, and the compositions of the two phases are such that the tracer substance preferentially partitions into the second aqueous phase so that the concentration of the tracer in the smaller second phase exceeds its concentration in the first aqueous phase;
separating the second fluid from the produced fluid, with the said tracer concentrated therein, and
analyzing the second aqueous phase for the tracer.

The tracer may be any of the substances which are known to be useful as tracers. A tracer may be a chemical with distinctive characteristics to aid detection and identification in high dilution, More specifically, a tracer may be a dye, fluorescer or other chemical which can be detected using spectroscopic analytical methods such as UV-visible, fluorescence or phosphorescence, or may be a chemicals with distinctive features which enables it to be distinguished by some other analytical technique such as GC-MS. Fluorocarbons have been suggested as a distinctive chemical for use as a tracer.

Another possibility is that the tracer could be a biological tag comprising genetically coded DNA, which could be detected in the produced fluid by means of real-time PCR as described in WO02007/132137 incorporated herein by reference.

Radio-isotopes have frequently been used as tracers. Society of Petroleum Engineers paper SPE109,969 discloses the use of materials which can be activated to become short lived radio-isotopes. When detected in produced fluid, radio-isotopes may be distinguished by characteristics of the emitted radiation. For instance a tracer could be an alpha-, a beta- or a gamma emitter with a characteristic energy of the emitted particles/radiation.

In a third aspect of this invention, the above method is used as treatment of the aqueous fluid produced via the wellbore, so as to extract the minor constituent into the second aqueous phase, the method further comprising using the first fluid from which the said constituent has been removed to make an aqueous composition which is delivered into a wellbore. In this aspect of the invention the constituent which is extracted may be lignosulphonate, possibly present as a result of earlier leakage of drilling fluid into the formation, the separated first phase may be used to make a wellbore cement which is delivered into a wellbore and the separated second phase may be discarded. The process may be carried out if lignosulphonate is known to be present, or may be carried out as a precaution to remove any lignosulphonate which may possibly be present.

Alternatively the minor constituent may be borate, the separated first phase may be used to make a hydraulic fracturing fluid which is delivered into a wellbore, and once again, the separated second phase may be discarded.

The process of the invention may be carried out with conventional process plant. Addition of solute may be carried out using a conventional mixer for adding solid or liquid to the aqueous fluid produced via a wellbore. Separation of the two phases may be carried out using conventional equipment for the separation of two liquid phases. Where the objective is analytical, the process of the invention may be applied to only part of the aqueous fluid produced from a wellbore: for instance a fraction of a flowing stream of fluid from a wellbore may be separated from the remainder and one or more analytes added to this fraction to begin the process of the invention. When the process is applied to a flowing stream of incoming aqueous fluid, it may be found expedient to re circulate some or all of the separated second phase into contact with freshly incoming fluid, so as to further increase the concentration of the minor constituent extracted into the second, smaller, aqueous phase.

### BRIEF DESCRIPTION OF THE DRAWINGS

FIG. 1 is a phase diagram for aqueous mixtures containing polyethylene glycol of about 1500 oxyethylene units (PEG 1500) and ammonium sulphate; the vertical axis is wt % PEG in the whole mixture, the horizontal axis is Molarity, i.e moles/litre, of ammonium sulphate in the whole mixture.

FIG. 2 is the analogous phase diagram for aqueous mixtures containing containing polyethylene glycol of about 3400 oxyethylene units (PEG 3400) and ammonium sulphate;

FIG. 3 diagrammatically shows use of the process to collect samples periodically;

FIG. 4 diagrammatically shows use of the process to provide a sample stream; and

FIG. 5 diagrammatically shows use of the process to treat water in preparation for cementing.

### DETAILED DESCRIPTION AND EXAMPLES

The following description gives examples of the chemistry involved in the process, followed by exemplification of putting the process into effect.

### Example 1

This example demonstrates the extraction of lignosulphonate. Chemicals used in this example were ammonium sulfate, lignosulfonic acid sodium salt (average molecular weight=8000), polyethylene glycol containing an average of 1500 oxyethylene units (PEG 1500), polyethylene glycol containing an average of 3400 oxyethylene units (PEG 3400). All of these chemicals were of analytical grade and used as received without further purification. Water was deionised water with a resistivity of 18.2MQ-cm (Millipore Milli-Q Academic ultrapure water system).

A number of aqueous mixtures were prepared at room temperature by mixing equal quantities of previously prepared solutions of polyethylene glycol and ammonium sulphate. This was done with both PEG 1500 and PEG 3400. In all of the mixtures the PEG solutions contained lignosulphonate at a concentration of 1 mg lignosulphonate per 1 g PEG. Each mixture was vortex mixed for 10 sec, allowed to stand for 10 min and centrifuged at 3000 rpm for 10 min. The occurrence of phase separation, as indicated by the presence of a distinct boundary between phases, was determined by visual inspection.

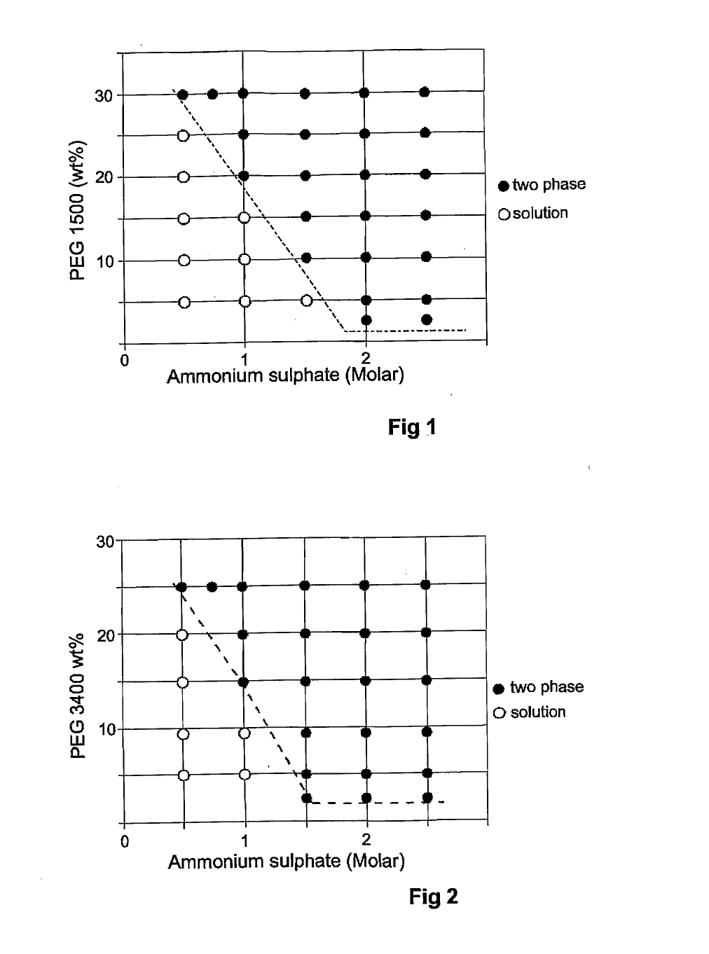

The observations of single phase or two phases after centrifuging were used to plot phase diagrams which are shown as FIG. 1 (for PEG 1500) and FIG. 2 (for PEG 3400). The dashed lines on these two Figures approximate the binodal lines which represent the critical concentrations of PEG and ammonium sulfate at which phase separation occurred. To the left of and below the binodal lines, where the points are shown as open circles, the aqueous mixture existed as a single homogeneous phase. To the right of and above the binodal lines, where the points are shown as filled circles, two discrete aqueous phases formed with one enriched in PEG and the other in ammonium sulphate. When phase separation occurred the upper layer was the PEG-rich phase and the lower layer was the salt-rich phase.

A series of biphasic mixtures containing several concentrations of PEG 3400 and a constant overall 3 Molar ammonium sulphate concentration were placed in graduated tubes and the volumes of the two phases were noted. At 10 wt % PEG, the salt-rich lower phase was three times the volume of the PEG-rich upper phase. At 30 wt % PEG the volumes of the phases were approximately equal. Intermediate proportions by volume were observed with overall PEG 3400 concentrations of 15 wt %, 20 wt % and 25 wt %.

Similarly, the volumes of the two phases were noted for mixtures containing overall 20 wt % PEG 3400 and increasing amounts of ammonium sulphate. When the overall concentration of ammonium sulphate was 1 Molar, the two phases were of approximately equal volume. When the overall concentration of ammonium sulphate was increased to 2.5 Molar, the lower, salt-rich phase was about three times the volume of the PEG-rich upper phase. Intermediate proportions by volume were observed with ammonium sulphate concentrations of 1.5 and 2 Molar.

For the mixture containing overall 20 wt % PEG and 2.5 Molar ammonium sulphate it was estimated from the phase diagram that the lower, salt-rich phase contained PEG at a concentration of not more than 2 wt % PEG while the smaller, PEG-rich upper phase contained not more than 0.5 Molar ammonium sulphate. The observed and calculated properties of this mixture are listed in the following table:

| | | PEG | ammonium sulphate |
|---|---|---|---|
| | volume | concentration | concentration |
| Overall | | 20 wt % | 2.5M |
| mixture | | | |
| Upper phase | 25% of total | 74 wt % | not more than 0.5M |
| Lower phase | 75% of total | not more than 2 wt % | 3.1M |

When two phases formed, the concentration of lignosulphonate in each phase was determined colorimetrically at 260 nm using a UV-Vis-NIR scanning spectrophotometer (Shimadzu UV-3101PC) and a calibration curve generated from PEG solutions containing lignosulfonic acid sodium salt at a range of known concentrations. The measured values were given as a distribution ratio, where

$$distribution ratio = \frac{concentration in upper phase}{concentration in lower phase}$$

It was observed that the lignosulphonate concentrated preferentially in the PEG-rich upper phase, typically with a concentration in the PEG-rich phase which was 40 or more times that in the salt-rich phase. The PEG-rich upper phase had the brown colour of lignosulphonate while the salt-rich lower phase was almost colourless. The distribution ratios for biphasic aqueous mixtures containing overall 20 wt % PEG and varying amounts of ammonium sulphate are given in the following table:

| | |
|---|---|
| Ammonium sulphate | Distribution ratios |

| concentration. | | PEG 1500 | PEG 3400 |
|---|---|---|---|
| 1 | mol/Litre | 42 | 50 |
| 1.5 | mol/Litre | 72 | 73 |
| 2 | mol/Litre | 95 | 85 |
| 2.5 | mol/Litre | 102 | 100 |

It can be seen that with constant overall concentration of PEG, the distribution ratio increased with the ammonium sulphate concentration. In the case of a mixture containing overall 20 wt % PEG 3400 and 2.5 Molar ammonium sulphate, the concentration of lignosulphonate is 100 times greater in the upper phase than in the lower phase but the lower phase was three times the volume of the upper phase. Hence, the weight ratio of lignosulphonate in the upper and lower phases was approximately 97:3 which means that separating off the upper phase would collect approximately 97% of the lignosulphonate.

For biphasic aqueous mixtures containing 10 to 30 wt % PEG and 1.5 Molar ammonium sulphate overall, the distribution ratios were approximately equal, suggesting that as the overall PEG concentration was increased, an increasing tendency to partition into the PEG-rich layer was being offset by an increasing volume of the PEG-rich phase, and that PEG concentration was having negligible net effect on the distribution ratio—provided, of course, that the PEG concentration was sufficient that phase separation occurred.

Other materials which partition strongly into a PEG-rich phase of a biphasic aqueous system contain PEG and an ionic salt include DNA and also whole biological cells. Consequently, the process of the invention could also be applied to the extraction of these biological materials into the smaller phase of an aqueous biphasic mixture.

### Example 2

This example demonstrates the extraction of an organic dye which could be used as a tracer. The first dye used was ethyl orange which is 4-(4-Diethylaminophenylazo)benzenesulfonic acid sodium salt. Separation into two phases was accomplished using sodium chloride and sodium neodecanoate, the latter being the sodium salt of highly branched C9 to C11 carboxylic acid available under the trademark VERSATIC acid from Hexion Specialty Chemicals, Inc., Columbus, Ohio. It will be appreciated that this is a salt of an organic acid of sufficient carbon chain length to have surface active properties, although branching of the carbon chain inhibits micelle formation.

A solution of ethyl orange in water was prepared. Sodium neodecanoate was added to this solution, which remained as a single phase coloured by the dye. Concentrated sodium chloride solution was then added and mixed with the sodium neodecanoate solution. The mixture separated into an upper phase rich in sodium neodecanoate and a lower phase rich in sodium chloride. Colouration by the dye showed that it had partitioned exclusively into the upper neodecanoate-rich phase, leaving the lower sodium chloride phase is almost colourless. This was confirmed by analysis by UV/visible spectroscopy, which did not detect any dye in the sodium chloride phase.

The same behaviour with complete partition into an upper, neodecanoate-rich phase was also observed with another water-soluble dye, Congo red, which is 4-amino, 3-(4-methylphenylazo)naphthalenesulphonic acid sodium salt.

As in the previous example the concentrations of the sodium neodecanoate and sodium chloride determined the volumes of the phases. A biphasic system with a small neodecanoate-rich phase and a larger salt-rich phase could be obtained using a moderate amount of sodium neodecanoate, typically 5 wt % overall and a substantial concentration of sodium chloride, such as 4 or 5 Molar.

### APPLICATION OF THE PROCESS

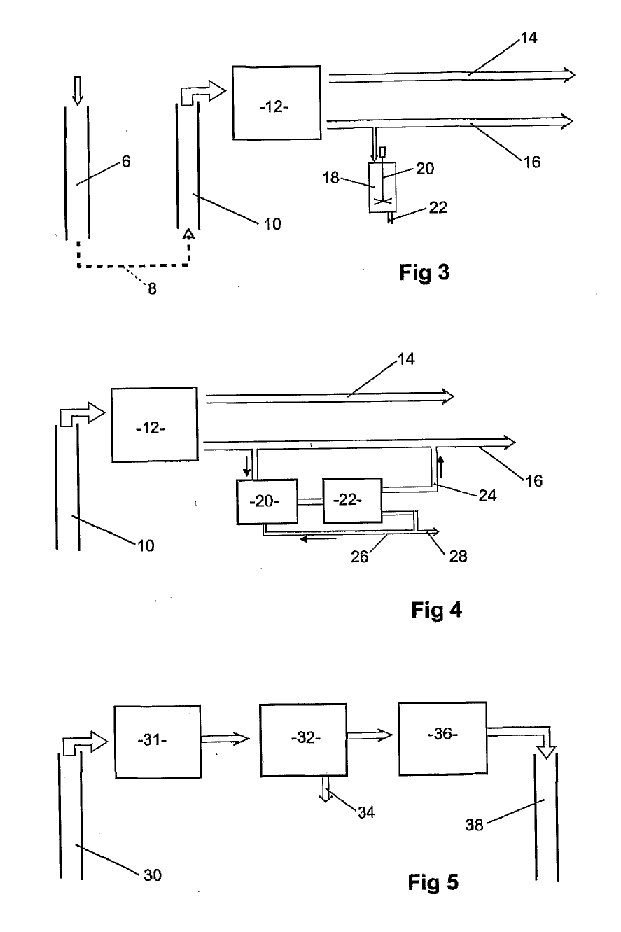

FIG. 3 illustrates putting the process into effect. Oil is being driven from subterranean reservoir by water injected through an injection well 6 which flows through the reservoir as indicated by dashed line 8. Oil and water are produced from wellbore 10 and flow to an oil/water separator 12 which separates a flow 14 of oil from a flow 16 of aqueous solution which is discharged to waste. The flow 16 may well be saline because it contains brine from the reservoir. In order to monitor the flow through the reservoir, a tracer dye such as ethyl orange is added to water entering the injection well 6. From time to time a sample of approximately 50 litres is taken from the aqueous flow 16 and collected in a vessel 18 which is caused to which solute(s) are added. Sodium neodecanoate and (if necessary) sodium chloride are mixed into the sample in vessel 18. The proportions of sodium chloride (and other inorganic salts present in the sample) and sodium neodecanoate are such that the overall aqueous mixture in the sample vessel 18 is made to contain at least 4 Molar inorganic salt(s) and 3 wt % sodium neodecanoate. After mixing the sample is left to stand and it settles into two layers. The bottom layer is a saline solution and is a large percentage of the total volume. By using a sufficiently high concentration of salt, the bottom layer can be made to have a volume of 45 litres or more. The top layer has a relatively small volume but contains most of the sodium neodecanoate and almost all of any tracer which was present in the sample. The bottom layer is drained from the sample vessel until the volume remaining in the sample vessel is approximately 5 litres. This 5 litres includes all or most of the top layer and hence contains almost all of the tracer in the original 50 litre sample taken from the flow 16. It is run into a 5 litre container and transported by helicopter and road vehicle to an analytical laboratory which analyses for the presence of organic dye.

FIG. 4 shows a somewhat similar separation carried out as a continuous process. The flow 16 of aqueous fluid is split so that approximately 10% of the flow goes to a mixer 20 where sodium neodecanoate and salt are added. The output of the mixer goes to a liquid/liquid separator 22 which separates the salt-rich phase from the neodecanoate-rich phase. The salt-rich phase is directed along line 24 into the flow 16 of aqueous fluid going to discharge. The neodecanoate-rich phase containing extracted tracer is split into two streams. About 80% of it is recycled to the mixer 20 so that it is exposed to further incoming aqueous fluid and so the concentration of tracer in the neodecanoate phase is further increased. The remaining 20% of the neodecanoate-rich flow from separator 22 is an output flow 28. Once steady state conditions have been established, quantities of this output flow are collected and sent for analysis.

FIG. 5 shows the process of the invention used to treat water which is then used for cementing. Water from an underground aquifer is produced from a wellbore 30 which is not yet producing any oil. This water is filtered and pumped into a mixer 31 where PEG 3400 and salt are added so that the composition contains approximately 10 wt % PEG and 10 wt % salt. The mixture then goes on to liquid liquid separator 32 where the smaller PEG-rich phase containing any lignosulphonate is separated and discharged at 34 while the larger salt containing phase is used to mix cement at 36. This cement is used for cementing a second wellbore 38.

1. A method of processing an aqueous fluid produced from a subterranean location via a wellbore, to extract a minor constituent therefrom, comprising adding one or more solutes to the aqueous fluid so as to form an aqueous mixture
which exists as first and second aqueous phases in contact with each other, the second aqueous phase having a smaller volume than the first aqueous phase, with the dissolved solutes segregated between the two phases such that at least one first solute is present at a greater concentration in the first aqueous phase than in the second aqueous phase while at least one second solute is present at a greater concentration in the second aqueous phase than in the first aqueous phase; and
wherein the compositions of the two phases are such that the said minor constituent preferentially partitions into the second aqueous phase so that the concentration of that constituent in the smaller second phase exceeds its concentration in the first aqueous phase; then separating the second aqueous phase with the said constituent concentrated therein from the first aqueous phase.

2. The method of claim 1 wherein the produced fluid contains at least 2% by weight of inorganic salts.

3. The method of claim 2 wherein an added solute comprises additional inorganic salt.

4. The method of claim 1 wherein an added solute comprises organic polymer.

5. The method of claim 4 wherein the organic polymer is polyethylene glycol.

6. The method of claim 1 wherein an added solute comprises surfactant.

7. The method of claim 1 wherein an added solute comprises a salt of an organic acid or base.

8. The method of claim 1 wherein the volume of the first aqueous phase is from 5 to 100 times the volume of the second aqueous phase.

9. The method of claim 1 wherein the volumes and compositions of the first and second aqueous phases are such that the amount of the said minor constituent in the second aqueous phase is at least 3 times the amount in the first aqueous phase.

10. The method of claim 1 wherein the separated second aqueous phase is subsequently subjected to analysis for the minor constituent.

11. The method of claim 1 wherein the separated second aqueous phase is subsequently transported by road, rail, sea or air and then subjected to analysis for the minor constituent.

12. The method of claim 1 wherein the separated first aqueous phase is subsequently incorporated into a composition which is pumped down a wellbore.

13. The method of claim 1 wherein the produced fluid is flowing as a stream from the wellbore and at least part of the separated second fluid is recirculated into contact with the flowing stream of produced fluid.

14. A method of investigating a subterranean reservoir, comprising steps of
placing at least one tracer substance in the reservoir,
causing or allowing the tracer substance to dissolve in aqueous reservoir fluid,
producing the fluid from the reservoir,
adding one or more solutes to the aqueous fluid so as to form an aqueous mixture
which exists as first and second aqueous phases in contact with each other, the second aqueous phase having a smaller volume than the first aqueous phase, with the dissolved solutes segregated between the two phases such that at least one first solute is present at a greater concentration in the first aqueous phase than in the second aqueous phase while at least one second solute is present at a greater concentration in the second aqueous phase than in the first aqueous phase; and
wherein the compositions of the two phases are such that the tracer substance preferentially partitions into the second aqueous phase so that the concentration of the tracer substance in the smaller second phase exceeds its concentration in the first aqueous phase;
separating the second aqueous phase with the said tracer substance concentrated therein from the first aqueous phase, and
analyzing the second aqueous phase for the tracer.

15. The method of claim 14 wherein the tracer is an organic compound

16. The method of claim 14 wherein the tracer comprises a water-soluble organic dye.

17. The method of claim 1 used as treatment of the aqueous fluid produced via the wellbore, so as to extract the minor constituent into the second aqueous phase, the method further comprising using the first fluid from which the said constituent has been removed to make an aqueous composition which is delivered into a wellbore.

18. The method of claim 17 wherein the minor constituent is lignosulphonate and the first aqueous phase is used to make a wellbore cement.
